(19) United States
(12) Patent Application Publication
(10) Pub. No.: US 2005/0111712 A9
(43) Pub. Date: May 26, 2005

(54) Process for controlling an image recording and control apparatus therefor

(75) Inventor: Reiner Jung, Langgoens (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Leica Microsystems Wetzlar GmbH, Wetzlar (DE)

(21) Appl. No.: 10/726,925

(22) Filed: Dec. 3, 2003

(30) Foreign Application Priority Data
Dec. 4, 2002 (DE) DE 102 56 706.9

(51) Int. Cl. G06K 9/00

(52) U.S. Cl. 382/128

(57) ABSTRACT

A method for controlling image recording includes actuating, using a control unit, equipment for the image recording. Image data of the recorded images is processed using a computer unit. Control commands for the image recording are combined to form a script. The script is transmitted from the computer unit to the control unit.

Priority is claimed to German patent application DE 102 56 706.9, which is hereby incorporated by reference herein.

The invention relates to a process for controlling an image recording which uses a control unit which actuates the equipment required to record the image and a computer unit which processes the data of the images recorded. The invention further relates to a suitable control apparatus and a suitable computer program product for controlling an image recording.

### BACKGROUND

In many image recording processes images of objects are recorded with a high time and/or spatial resolution and these images are subsequently processed to form film sequences and/or three-dimensional images. One example is the observation and analysis of changes in living cells.

WO 99/39184, for example, discloses a process and an apparatus for recording and analysing images of biological material. The material contained in a specimen dish is imaged by a microscope and the images are picked up by a camera. The slide stage is moved in spatial directions X, Y and Z, for which purpose a computer comprises a corresponding slide stage module software which controls the movement of the slide stage for a scanning operation by means of a slide stage control unit. The images recorded during the scanning operation of the camera are digitalised in the computer and then the image is evaluated by means of an image processing software module. This apparatus makes it possible to capture the image of living cells, labelled for example with radioactive or fluorescent substances, and to evaluate the images for different criteria such as absorption, fluorescence intensity or morphology.

The images are recorded and evaluated according to the above-mentioned publication WO 99/39184, which is hereby incorporated by reference herein, by means of a software module provided in a computer. This restricts the speed of imaging which can be achieved with this experimental arrangement. On the one hand the computer has to control the scanning operation and on the other hand it has to implement the image processing and evaluation.

An image analysis system developed by Olympus Deutschland and T.I.L.L. Photonics GmbH is also known for recording and analysing processes which change very rapidly in time (for example in living cells). The system is supposed to yield three-dimensional images with a high time resolution. It comprises a fluorescence microscope and a piezofocus for adjustment along the Z axis. The images are collected by means of a CCD camera. The fluorescence excitation is carried out by means of a lattice monochromator. In addition the system comprises a microcontroller for actuating the system components and a personal computer (PC) for recording the images at a rate of up to 200 Hz.

A disadvantage of this system is its limited reproducibility and flexibility, as the control unit (microcontroller) controls the system components according to a fixed predetermined control program which has to be adapted to the particular experimental set-up used. In a system of this kind the user has no way of flexibly and easily exchanging or modifying the control program as the experimental set-up changes.

### SUMMARY OF THE INVENTION

An object of the present invention therefore is to make it possible to record images with a high time and/or spatial resolution, while further increasing the running speed of the image recording, and at the same time obtaining greater flexibility and reproducibility.

The present invention provides a process for controlling image recording which uses a control unit which actuates the equipment required for the image recording, as well as a computer unit which processes the data of the images recorded, in which control commands for image recording are combined according to the invention into at least one script and at least one script is transmitted from the computer unit to the control unit.

According to the present invention, the control unit (e.g., a controller) and computer unit (e.g., a PC) are thus responsible for different tasks in the image recording, the control unit essentially actuating the various pieces of equipment such as the microscope, camera, slide stage, etc., while the computer unit is essentially intended to receive and process the image data. At the same time, according to the invention, the individual control commands for the control unit are combined to form a so-called script and are transmitted as a unit (script) to the control unit, while the script may be translated into machine code (compiled) before or after the transmission.

The control of the individual pieces of equipment is then carried out in the control unit by interpretation (running) of the script (macro) or by generating the machine code once and executing this code, providing a speed advantage.

The advantages achieved are a higher running speed as the different tasks (controlling the slide holder, recording the image data, etc.) can be carried out by a number of processors, higher flexibility as existing scripts can easily be amended by the user on the computer unit, and precise reproducibility as a script can be held on the computer unit and transmitted to the control unit for execution once again as necessary.

It is advantageous to encrypt the script in order to be able to define different rights of access (reading, writing, etc.) or to be able to select the transmission of scripts.

It is advantageous to store a number of scripts in the computer unit. Depending on the experimental set-up a user can then select a suitable script to control the image recording. It is also possible and advantageous to set up a new script on the computer unit or amend and/or add to such a script. This allows flexible reaction to changes in requirements.

It is also advantageous if only the script to be executed at that moment is transmitted by the computer unit to the control unit and if only this script is present in the control unit at that time. This increases the reproducibility and frees up the control unit.

A control apparatus according to the invention for controlling an image recording comprises a control unit for actuating equipment required for the image recording and a computer unit for processing data of the images recorded, the computer unit being adapted to provide at least one script which combines control commands for the image recording and is connected to the control unit in order to transmit at least one script.

It is advantageous if the computer unit is equipped with a memory unit for storing a plurality of scripts. It is also advantageous if the computer unit is provided with input and display means for writing new scripts and amending and/or adding to existing scripts.

An advantageous use of the invention is in multi-dimensional image recording. In 3D image recording, for example, it is essential to record the series of images at the maximum possible speed. An apparatus which is suitable for this purpose contains a camera which takes a picture of an object captured by a microscope and transmits it to a computer unit. In the computer unit the image data are recorded and further processed. The apparatus may further comprise lighting means for illuminating the object with a suitable frequency at which fluorescence can be excited, for example. In addition, a specimen moving device may be provided for moving the specimen in controlled manner in space to allow it to be scanned, for example. Alternatively, the microscope may be moved for this purpose. The apparatus mentioned above is now provided with the control apparatus according to the invention as described above.

The above apparatus can be used to record and process multi-dimensional images (for example of living cells) at high speed. The following steps are involved:
a) Setting the Z plane (on the microscope or by moving the slide stage with a piezo)
b) Setting the wavelength (using a monochromator a single wavelength or range of wavelengths can be selected for illuminating the object)
c) Opening the shutter
d) Taking the picture
e) Closing the shutter.

In order to take a series of pictures steps a) to e) are repeated as often as required. A series of pictures of one or more living cells is obtained. This series of pictures is further processed by additional software. The speed of recording of the series of images has to be adapted to the object under investigation or the processes under investigation. The equipment required for recording the images in this case comprises a microscope, a light-sensitive camera, a monochromator, a piezo element and a shutter (shut-off device for light-sensitive samples). These components are actuated by a control unit according to a process defined hereinbefore according to steps a) to e).

According to the invention, depending on the particular experimental set-up, a script is written, i.e. a sequence of individual control commands for the control unit, and this script may already be written on the computer unit of the above mentioned apparatus. Alternatively, it is possible to select a suitable script from a number of scripts saved in the computer unit. The script is then transmitted from the computer unit to the control unit. At the start of the image recording, the computer unit sends a starting signal to the control unit. Thus, both units can be triggered, the computer unit starting to record the image data while the control unit starts to control the equipment required for recording the images.

The control process according to the invention may expediently be carried out using a computer program which is run on a suitable computer unit. This computer program may also allow scripts to be written, selected and amended. It takes over the job of transmitting a script from the computer unit to the control unit. Finally, it may be used to generate starting signals to the control unit to start the image recording.

The computer program may be stored on suitable data carriers such as EEPROMS, flash memories and also CD-ROMs, diskettes or disk drives. It is also known to download a program through internal or publicly useable networks.

### BRIEF DESCRIPTION OF THE DRAWINGS

The invention will now be described in more detail with reference to an exemplifying embodiment with the aid of the accompanying figures.

FIG. 1 diagrammatically shows a system for multi-dimensional image recording with a control apparatus according to the invention.

FIG. 2 shows the flow diagram of a process for recording images according to the invention.

### DETAILED DESCRIPTION

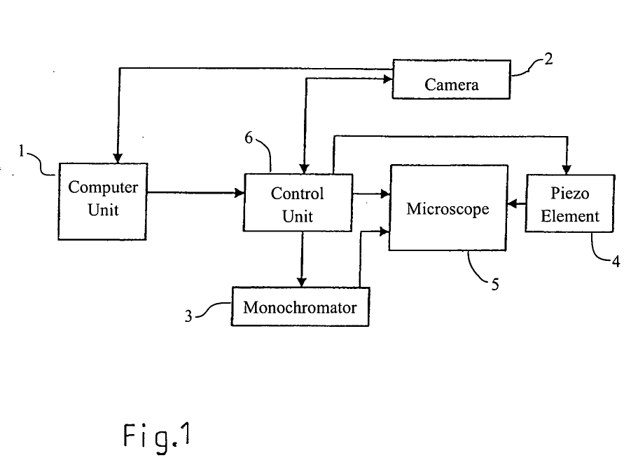

FIG. 1 diagrammatically shows an experimental set-up for three-dimensional image recording for the observation and analysis of changes in living cells. The pieces of equipment required for the image recording are diagrammatically shown, namely a microscope 5, a monochromator 3 which serves to illuminate the object with monochromatic light, a piezo element 4, which is able to move the slide stage in the Z direction and a camera 2 which is a light-sensitive digital camera to record the images of the microscope and prepare them for further processing. The computer unit 1 (e.g., a PC) and the control unit 6 (e.g., a controller) are also shown.

The arrows shown in FIG. 1 indicate the interaction of the system components. The general interplay of the individual pieces of equipment used for recording images and the control unit 6 is defined in a suitable script (macro). This is expediently written in the computer unit 1 and saved therein in order to be activated at a later time. This script defines the time sequence and plan according to which the individual pieces of equipment (camera 2, microscope 5, piezo element 4 and monochromator 3) will be activated. After the script has been finished it is transmitted to the control unit 6 by suitable commands. The control unit 6 is then capable of running this script and converting the control commands contained therein for the individual pieces of equipment into corresponding signals for actuating this equipment. This machine code generated by the control unit can now be executed very rapidly by the equipment.

In order to start the sequence a starting signal is sent by the computer unit 1. The control unit 6 starts by actuating the equipment required for the image recording. At the computer end, after the starting signal, the image data from the camera 2 are received as raw data and are available for further processing. After the script has been run in the control unit 6 all the image data are available in the computer unit 1. The control unit 6 is now ready to execute the script once more or to receive a different script from the computer unit 1 and start up. Advantageously, the control unit 6 contains only the script which is to be executed at that moment.

At the computer end it is possible to have a plurality of scripts in readiness. Thus, suitable scripts can be sent again and executed, providing reproducibility. The flexibility is provided by the ease of amendment of scripts at the computer end. As the control of the image recording equipment and the receiving and evaluation of the data are carried out separately, the running speed and hence the image frequency which can be achieved is increased significantly.

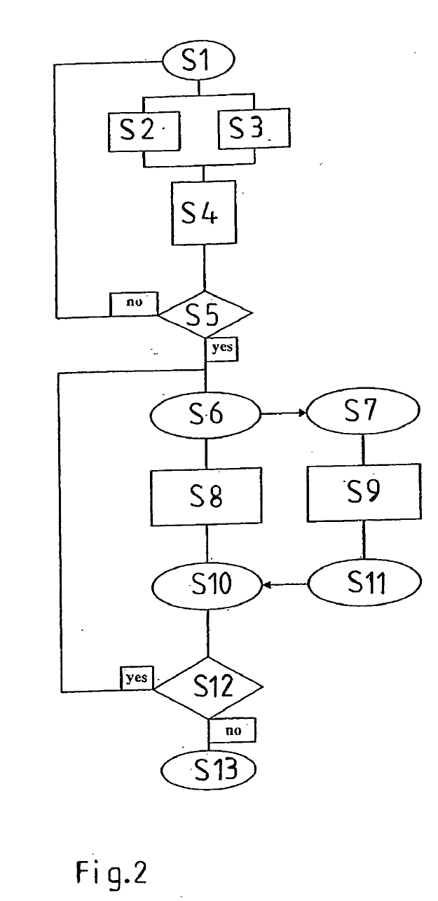

FIG. 2 shows an example of a process according to the invention for controlling the image recording which may be used for the experimental set-up described above. The running of the process described may expediently be taken over by a computer program.

Steps S1 to S5 serve to prepare the image recording whereas Steps S6 to S13 serve for the actual recording of images. In Step S1 a program for recording images is set in operation which makes it possible to produce a script (Step S2) or to load an existing script (Step S3). For safety's sake Step S4 comprises a syntax check in order to uncover any errors in the script and thus prevent control errors occurring during the actual image recording. In Step S5 the results of the syntax check in Step S4 are reported and if the result is negative the process returns to the start (S1) while if it is positive the actual image recording can begin.

If the syntax check is negative the script in question can easily be amended on the computer unit 1 (cf. FIG. 1) (Step S2) or a new script can be selected (Step S3).

After a positive syntax check the actual image recording begins, with the script in question being transmitted from the computer unit 1 to the control unit 6 in Step S6. At the same time, in this case, a starting signal is transmitted so that the control unit 6 can start to run the script (Step S7). While the script is being run in Step S9, at the same time the image data are received by the computer unit 1 in Step S8. The image data received are processed, for example, into three-dimensional image sequences or certain processes are analysed and evaluated. After the script has been run (S11) the control unit can transmit an end signal to the computer unit 1 (Step S10). The computer unit then stops recording image data.

In Step S12 an evaluation is made as to whether the script selected should be run again to record additional image data. If so, the process returns to Step S6 and if not the procedure comes to an end (S13).

If the experimental set-up is altered the procedure is started again by starting at Step 1.

The invention makes it possible to achieve multi-dimensional image recording at speeds which are suitable for the investigation of changes in living objects, such as cells.

1. A method for controlling image recording, comprising:
actuating, using a control unit, equipment for the image recording;
processing, using a computer unit, image data of the image recording;
combining a plurality of control commands for the image recording so as to form at least one script; and
transmitting the at least one script from the computer unit to the control unit.

2. The method as recited in claim 1 wherein the at least one script includes a plurality of scripts and further comprising saving a plurality of scripts in the computer unit.

3. The method as recited in claim 1 wherein the combining is performed using the computer unit so as to at least one of newly generate, amend and supplement the at least one script.

4. The method as recited in claim 1 further comprising sending a starting signal to the control unit using the computer so as to start the image recording.

5. The method as recited in claim 1 wherein the transmitting is performed by transmitting to the control unit only a respective script of the at least one script to be executed at a given time.

6. The method as recited in claim 1 further comprising encrypting the at least one script.

7. A control apparatus for controlling image recording, comprising:
a control unit configured to actuate equipment for the image recording; and
a computer unit configured to process image data of the image recording and to provide at least one script including a plurality of control commands for the image recording, the computer unit being connectable to the control unit so as to enable a transmitting of the at least one script.

8. The control apparatus as recited in claim 7 wherein the least one script includes a plurality of scripts.

9. The control apparatus as recited in claim 7 wherein the computer unit is configured to at least one of generate, amend and supplement the at least one script.

10. The control apparatus as recited in claim 7 wherein the computer unit is configured to transmit a starting signal to the control unit.

11. The control apparatus as recited in claim 7 wherein the control unit is configured so that only a respective script of the at least one script to be run at a given time is resident in the control unit.

12. An apparatus for multi-dimensional image recording, comprising:
a control unit configured to initiate the image recording;
a camera configured to record an image of an object captured by a microscope so as to form image data;
a computer unit configured to receive and process the image data and to provide at least one script including a plurality of control commands for the image recording, the computer unit being connectable to the control unit so as to enable a transmitting of the at least one script.

13. The apparatus as recited in claim 12 further comprising an illuminating device configured to illuminate the object.

14. The apparatus as recited in claim 12 further comprising a moving device configured to move the object.

15. A computer readable medium having stored thereon computer executable process steps operative to perform a method for controlling image recording, the method comprising:
actuating, using a control unit, equipment for the image recording;
processing, using a computer unit, image data of the image recording;
combining a plurality of control commands for the image recording so as to form at least one script; and
transmitting the at least one script from the computer unit to the control unit.

16. The computer readable medium as recited in claim 15 wherein the computer executable process steps are executable using the computer unit.

17. The computer readable medium as recited in claim 15 wherein the computer executable process steps are executable using the control unit.
